(19) United States
(12) Patent Application Publication
(10) Pub. No.: US 2011/0064441 A1
(43) Pub. Date: Mar. 17, 2011

(54) Temperature Control Method for Fixing Device

(75) Inventor: Kazushige MORIHARA, Kanagawa (JP)

(73) Assignees: Kabushiki Kaisha Toshiba, Tokyo (JP); Toshiba Tec Kabushiki Kaisha, Tokyo (JP)

(21) Appl. No.: 12/873,256

(22) Filed: Aug. 31, 2010

Related U.S. Application Data
(60) Provisional application No. 61/242,731, filed on Sep. 15, 2009.

(51) Int. Cl. G03G 15/20

(52) U.S. Cl. 399/69; 399/70

(57) ABSTRACT

A fixing device includes: a fixing member configured to cause a recording medium to pass therethrough and subject the recording medium to fixing processing; a heating member configured to heat the fixing member; and a control member configured to control the heating member at two fixing set temperatures during a printing mode for the recording medium fed last.

### CROSS-REFERENCE TO RELATED APPLICATION

This application is based upon and claims the benefit of priority from Provisional U.S. Application 61/242,731 filed on Sep. 15, 2009, the entire contents of which are incorporated herein by reference.

### FIELD

Embodiments described herein relate generally to temperature control for a fixing device used in an image forming apparatus such as a color copying machine or a MFP (multi-functional peripheral).

### BACKGROUND

An image forming apparatus has a startup mode, a printing mode, a standby mode, a sleep mode, and the like. Set temperature for controlling the temperature of a fixing device is changed according to a change of a mode of the image forming apparatus. In conventional, while the image forming apparatus maintains the printing mode, fixing set temperature for controlling the temperature of the fixing device is fixed without being changed. The image forming apparatus controls the fixing device at the fixing set temperature until the last sheet passes through the fixing device and the image forming apparatus finishes the printing mode. When the image forming apparatus finishes the printing mode and changes the printing mode to the standby mode, the image forming apparatus changes the set temperature of the fixing device from the fixing set temperature to standby temperature during standby.

However, if the image forming apparatus controls the fixing device at the fixing set temperature until the image forming apparatus finishes the printing mode, the set temperature of the fixing device changes to the fixing set temperature when the last sheet passes through the fixing device. Even if the image forming apparatus changes the set temperature of the fixing device to standby set temperature after finishing the printing mode, it is likely that the fixing device is overshoot (abnormally overheated) after the passage of the last sheet because of time lag and electric power is wastefully consumed. It is also likely that influence on image quality and influence on peripheral apparatuses are caused by the overshoot.

Therefore, there is a demand for development of an image forming apparatus that prevents the overshoot of the fixing device, saves power consumption, and realizes improvement of image quality and safety of the apparatus.

### BRIEF DESCRIPTION OF THE DRAWINGS

FIG. 1 is a schematic diagram of a color copying machine according to a first embodiment;

FIG. 2 is a schematic diagram of a fixing device according to the first embodiment viewed from a side;

FIG. 3 is a block diagram of a control system for an IH coil according to the first embodiment;

FIG. 4 is a flowchart for explaining setting of a startup mode according to the first embodiment;

FIG. 5 is a flowchart for explaining setting of a standby mode 1 according to the first embodiment;

FIG. 6 is a flowchart for explaining setting of a printing mode according to the first embodiment;

FIG. 7 is a flowchart for explaining setting of a last paper printing mode according to the first embodiment;

FIG. 8 is a flowchart for explaining setting of a standby mode 2 according to the first embodiment;

FIG. 9 is a flowchart for explaining control of the fixing device according to the first embodiment;

FIG. 10 is a timing chart for explaining a control example 1 of the IH coil according to the first embodiment;

FIG. 11 is a flowchart for explaining setting of a startup mode of a comparative example 1 of the first embodiment;

FIG. 12 is a flowchart for explaining setting of a standby mode of the comparative example 1 of the first embodiment;

FIG. 13 is a flowchart for explaining setting of a printing mode of the comparative example 1 of the first embodiment;

FIG. 14 is a timing chart for explaining the comparative example 1 of the first embodiment;

FIG. 15 is a timing chart for explaining a control example 2 of the IH coil according to the first embodiment;

FIG. 16 is a timing chart for explaining a comparative example 2 of the first embodiment;

FIG. 17 is a schematic diagram of a fixing device according to a second embodiment viewed from a side;

FIG. 18 is a block diagram of a control system for a fixing heater according to the second embodiment;

FIG. 19 is a flowchart for explaining setting of a startup mode according to the second embodiment;

FIG. 20 is a flowchart for explaining setting of a standby mode 1 according to the second embodiment;

FIG. 21 is a flowchart for explaining setting of a printing mode according to the second embodiment;

FIG. 22 is a flowchart for explaining setting of a last paper printing mode according to the second embodiment;

FIG. 23 is a flowchart for explaining setting of a standby mode 2 according to the second embodiment;

FIG. 24 is a flowchart for explaining control of the fixing device according to the second embodiment;

FIG. 25 is a timing chart for explaining a control example 3 of the fixing heater according to the second embodiment;

FIG. 26 is a timing chart for explaining a comparative example 3 of the second embodiment;

FIG. 27 is a timing chart for explaining a control example 4 of the fixing heater according to the second embodiment; and

FIG. 28 is a timing chart for explaining a comparative example 4 of the second embodiment.

### DETAILED DESCRIPTION

In general, according to an embodiment, a fixing device includes: a fixing member configured to cause a recording medium to pass therethrough and subject the recording medium to fixing processing; a heating member configured to heat the fixing member; and a control member configured to control the heating member at two fixing set temperatures during a printing mode for the recording medium fed last.

Embodiments are explained below.

### First Embodiment

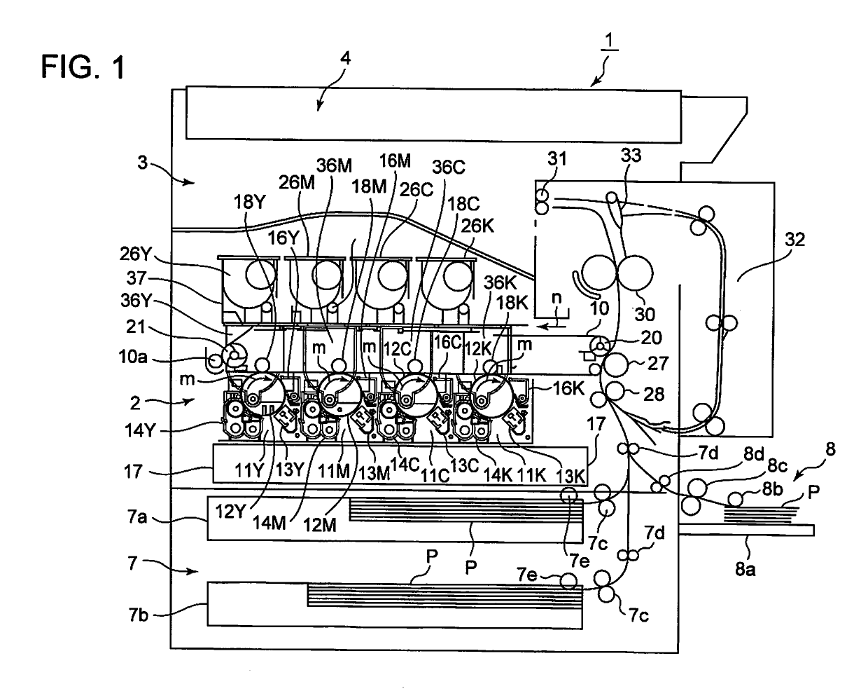

A color copying machine 1 as an image forming apparatus shown in FIG. 1 includes a printer section 2 configured to form an image, a paper discharge section 3 configured to accumulate sheets P, which are recording media, discharged from the printer section 2, a scanner section 4 configured to read a document image, a paper feeding device 7 configured to feed the sheets P, and a bypass paper feeding device 8.

The printer section 2 includes four image forming stations 11Y, 11M, 11C, and 11K arranged in parallel along a lower side of an intermediate transfer belt 10. The image forming stations 11Y, 11M, 11C, and 11K respectively include photoconductive drums 12Y, 12M, 12C, and 12K. The image forming stations 11Y, 11M, 11C, and 11K respectively form toner images of Y (yellow), M (magenta), C (cyan), and K (black) on the photoconductive drums 12Y, 12M, 12C, and 12K.

The photoconductive drums 12Y, 12M, 12C, and 12K rotate in an arrow m direction. The image forming stations 11Y, 11M, 11C, and 11K respectively include, around the photoconductive drums 12Y, 12M, 12C, and 12K, electrifying chargers 13Y, 13M, 13C, and 13K, developing devices 14Y, 14M, 14C, and 14K, and photoconductive member cleaners 16Y, 16M, 16C, and 16K.

A laser exposure device 17 irradiates exposure lights on the photoconductive drums 12Y, 12M, 12C, and 12K to form electrostatic latent images on the photoconductive drums 12Y, 12M, 12C, and 12K respectively. The electrifying chargers 13Y, 13M, 13C, and 13K and the laser exposure device 17 configure a latent-image forming section. The developing devices 14Y, 14M, 14C, and 14K respectively supply toners to the electrostatic latent images on the photoconductive drums 12Y, 12M, 12C, and 12K to visualize the electrostatic latent images.

The printer section 2 includes, above the respective developing devices 14Y, 14M, 14C, and 14K, toner cartridges 26Y, 26M, 26C, and 26K configured to respectively supply toners of Y, M, C, and K to the developing devices 14Y, 14M, 14C, and 14K through sub-hopper units 36Y, 36M, 36C, and 36K. The toner cartridges 26Y, 26M, 26C, and 26K are attached to and detached from a cartridge holding section 37.

A backup roller 20 and a driven roller 21 of the intermediate transfer belt 10 stretch and suspend the intermediate transfer belt 10. The intermediate transfer belt 10 rotates in an arrow n direction. Primary transfer rollers 18Y, 18M, 18C, and 18K respectively primarily transfer the toner images on the photoconductive drums 12Y, 12M, 12C, and 12K onto the intermediate transfer belt 10. The photoconductive member cleaners 16Y, 16M, 16C, and 16K respectively remove and collect residual toners on the photoconductive drums 12Y, 12M, 12C, and 12K after the primary transfer.

The printer section 2 includes a secondary transfer roller 27 opposed to the intermediate transfer belt 10. The printer section 2 secondarily transfers the toner images on the intermediate transfer belt 10 onto the sheet P passing between the intermediate transfer belt 10 and the secondary transfer roller 27. Paper feeding cassettes 7a and 7b or the bypass paper feeding device 8 feeds the sheets P one by one in synchronization with the toner images on the intermediate transfer belt 10. After the secondary transfer finishes, a belt cleaner 10a cleans the intermediate transfer belt 10.

The color copying machine 1 includes, between the paper feeding device 7 and the secondary transfer roller 27, pickup rollers 7e, separation rollers 7c, conveying rollers 7d, and a registration roller pair 28. The color copying machine 1 includes, between a manual feed tray 8a of the bypass paper feeding device 8 and the registration roller pair 28, a manual feed pickup roller 8b, a manual feed separation roller 8c, and a manual feed conveying roller 8d. The color copying machine 1 includes, along a conveying direction of the sheet P, a fixing device 30 further downstream than the secondary transfer roller 27.

The color copying machine 1 includes, downstream of the fixing device 30, a gate 33 configured to direct the sheet P to the direction of a paper discharge roller 31 or the direction of a re-conveying unit 32. The color copying machine 1 discharges the sheet P, which reaches the paper discharge roller 31 from the gate 33, to the paper discharge section 3. The re-conveying unit 32 leads the sheet P to the direction of the secondary transfer roller 27 again.

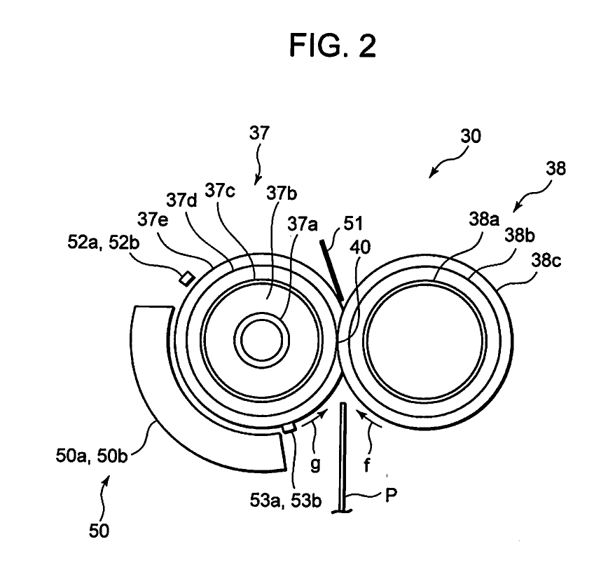

The fixing device 30 includes, as shown in FIG. 2, a heat roller 37 and a press roller 38 included in a fixing member and an induction heating coil (hereinafter abbreviated as IH coil) 50, which is a heating member, configured to heat the heat roller 37 with induction current. The fixing member is not limited to a roller type and may be a belt type. The heating member may heat the press roller 38.

In the heat roller 37, a foamed rubber (sponge) layer 37b having thickness of 5 mm, a metal layer 37c of nickel (Ni) having thickness of 40 μm, a solid rubber layer 37d made of silicon rubber having thickness of 20 μm, and a release layer 37e made of a PFA tube are sequentially laminated around, for example, a cored bar 37a. A material of the metal layer 37c may be stainless steel, aluminum (Al), a composite material of stainless steel and aluminum, or the like. In the press roller 38, a silicon sponge rubber layer 38b and a fluorine rubber layer 38c are laminated around, for example, a cored bar 38a.

The press roller 38 comes into press-contact with the heat roller 37 to form a nip 40 having fixed width between the heat roller 37 and the press roller 38. The press roller 38 is drivingly rotated in an arrow f direction. The heat roller 37 is driven to rotate in an arrow g direction following the press roller 38. The press roller 38 and the heat roller 37 cause the sheet P to pass through the nip 40 and heat and press a toner image and fix the toner image on the sheet P.

High-frequency current is applied to the IH coil 50 to generate a magnetic flux, whereby eddy-current is generated in the metal layer 37c of the heat roller 37. The surface of the heat roller 37 is heated by Joule heat generated by the eddy-current and the resistance of the metal layer 37c. The IH coil 50 includes a center coil 50a configured to heat the center area of the heat roller 37 and side coils 50b configured to heat areas on both sides of the heat roller 37. For example, when an image is fixed on the sheet P having width of the “A4” landscape size (210 mm) of the JIS standard, electric power is supplied to the center coil 50a to heat the center area of the heat roller 37. When the entire length of the heat roller 37 is heated, electric power is alternately supplied to the center coil 50a and the side coils 50b. Electric power may be simultaneously supplied to the center coil 50a and the side coils 50b.

A peeling pawl 51, non-contact first and second thermistors 52a and 52b, which are temperature sensors, and first and second thermostats 53a and 53b are arranged on the outer circumference of the heat roller 37.

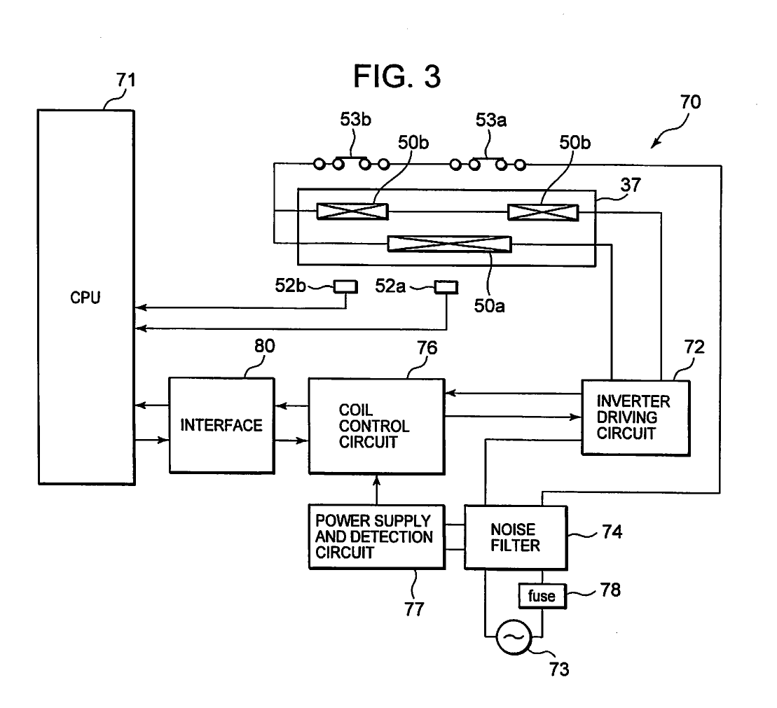

A control system 70 for the IH coil 50 includes, as shown in FIG. 3, an inverter driving circuit 72 configured to supply electric power to the center coil 50a and the side coils 50b, a noise filter 74 configured to rectify electric current from a commercial AC power supply 73 and supply the electric current to the inverter driving circuit 72, a coil control circuit 76, which is a control member, configured to control the inverter driving circuit 72, a power supply and detection circuit 77 configured to detect an output of the noise filter 74 and feed back the output to the noise filter 74 to fix electric power from the commercial AC power supply 73, and a fuse 78. The first or second thermostat 53a or 53b interrupts power supply from the commercial AC power supply 73 to the IH coil 50 when the heat roller 37 is abnormally overheated.

The coil control circuit 76 is connected, via an interface 80, to a CPU 71 configured to control the entire color copying machine 1. The CPU 71 controls a high-voltage power supply necessary for image formation of the color copying machine 1, a motor used for, for example, conveyance of the sheet P, and other operations of the color copying machine 1. Temperature detection results of the first and second thermistors 52a and 52b are input to the CPU 71.

The CPU 71 notifies the coil control circuit 76 of an operation state according to a mode of the color copying machine 1 such as a startup mode, a printing mode, a standby mode, or a sleep mode.

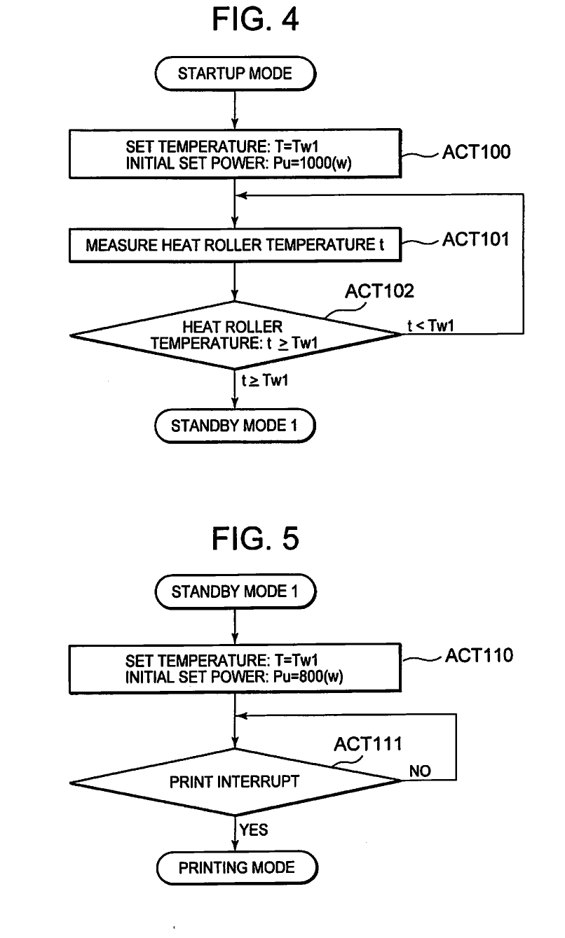

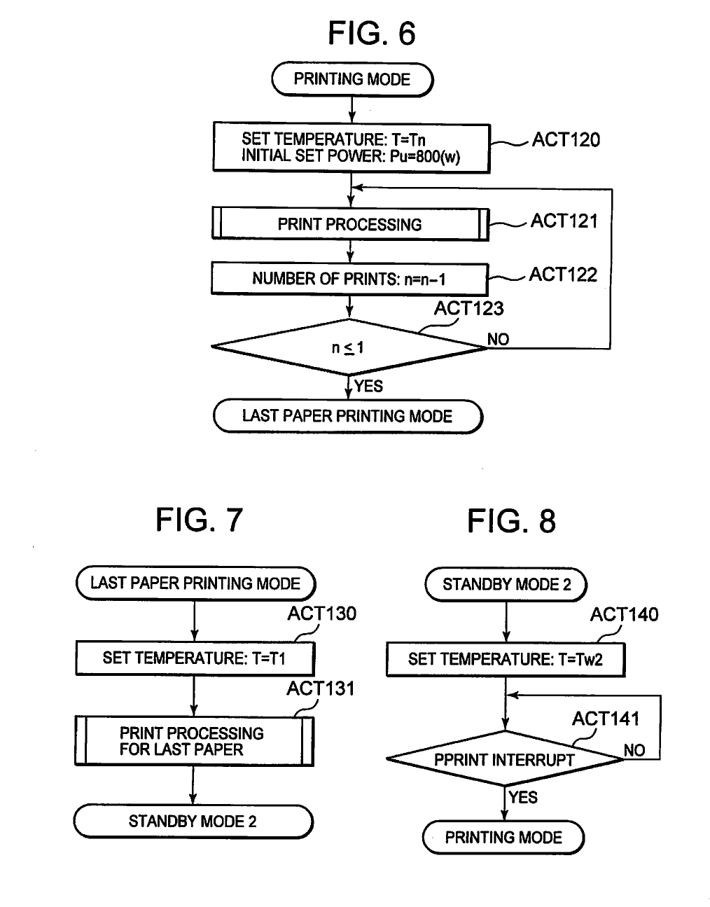

Setting for control of the IH coil 50 is explained with reference to FIGS. 4 to 8. According to power-on or return from the sleep mode, the CPU 71 starts the startup mode. The startup mode is in a period from a cooled state of the fixing device 30 to the standby mode. At the start of the startup mode, the coil control circuit 76 sets the set temperature T of the IH coil 50 to set temperature Tw1 (e.g., 170° C.) and sets initial set power Pu of the IH coil 50 to 1000 W (ACT 100). In ACT 101, the first and second thermistors 52a and 52b measure heat roller temperature t. In ACT 102, the CPU 71 waits for the heat roller temperature t to be equal to or higher than the set temperature Tw1. If the heat roller temperature t is equal to or higher than the set temperature Tw1 in ACT 102, the CPU 71 shifts to a standby mode 1.

In the standby mode 1, the CPU 71 keeps the set temperature T of the IH coil 50 at the same set temperature Tw1 as set temperature for startup and the coil control circuit 76 sets the initial set power Pu to 800 W (ACT 110). The CPU 71 stands by for occurrence of a print interrupt (ACT 111). If a print interrupt occurs (Yes in ACT 111), the CPU 71 shifts to the printing mode.

At the start of the printing mode, the CPU 71 sets the set temperature T of the IH coil 50 to set temperature Tn (e.g., 180° C.), which is first fixing set temperature, and sets the initial set power Pu by the coil control circuit 76 to 800 W (ACT 120). The color copying machine 1 performs print processing (ACT 121). The CPU 71 subtracts 1 from the number of prints n every time the print processing is performed (ACT 122) and, if the number of prints n is equal to or smaller than 1 (Yes in ACT 123), shifts to a last paper printing mode.

During the last paper printing mode, the CPU 71 sets the set temperature T of the IH coil 50 to set temperature T1 (e.g., 160° C.), which is second fixing set temperature (ACT 130). The color copying machine 1 performs print processing for last paper (ACT 131). The CPU 71 shifts to a standby mode 2.

In the standby mode 2, the CPU 71 sets the set temperature T of the IH coil 50 to set temperature Tw2 (e.g., 160° C.), which is standby set temperature (ACT 140). The CPU 71 stands by for occurrence of a print interrupt (ACT 141). If a print interrupt occurs (Yes in ACT 141), the CPU 71 shifts to the printing mode.

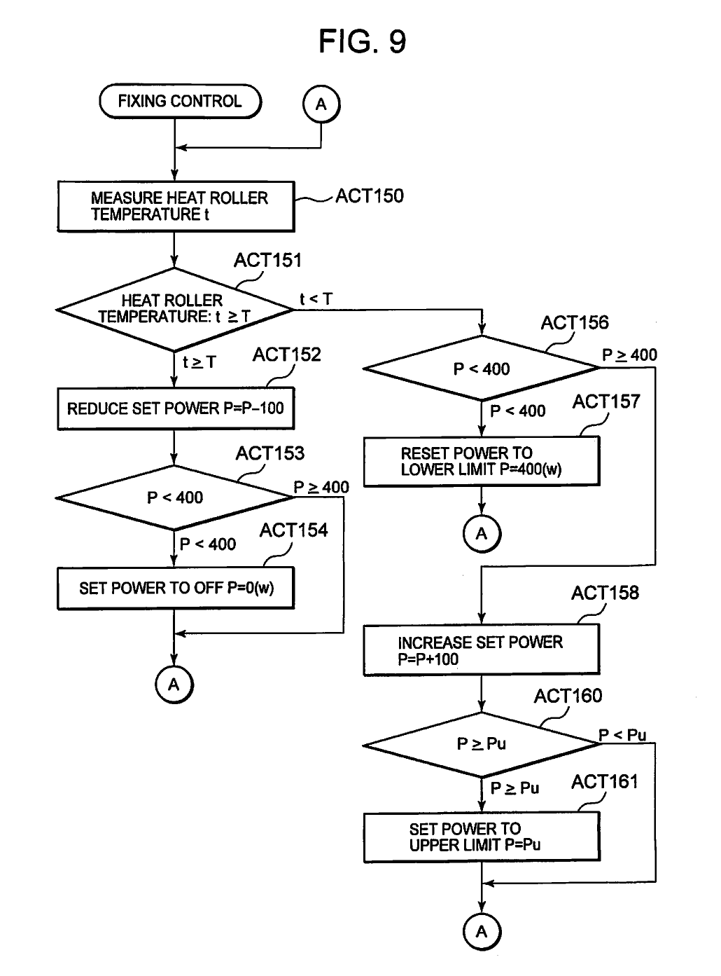

While the setting for control of the IH coil 50 shown in FIGS. 4 to 8 is carried out, the fixing device 30 performs fixing control according to a flowchart shown in FIG. 9. In the fixing device 30, the first and second thermistors 52a and 52b measure heat roller temperature t in fixing by the heat roller 37 (ACT 150). If the measured heat roller temperature t is equal to or higher than the set temperature T in ACT 151, the coil control circuit 76 reduces the set power P of the IH coil 50 by, for example, 100 W (ACT 152) and proceeds to ACT 153. The set power P of the IH coil 50 fluctuates when the heat roller temperature t changes.

The set temperature T in ACT 151 is, for example, T=Tw1 in the startup mode and the standby mode 1, T=Tn in the printing mode, T=T1 in the last paper printing mode, and T=Tw2 in the standby mode 2. If the set power P of the IH coil 50 is smaller than 400 W in ACT 153, the coil control circuit 76 sets electric power of the IH coil 50 to OFF (the set power P=0 W) (ACT 154). If the set power P of the IH coil 50 is equal to or larger than 400 W in ACT 153, the coil control circuit 76 returns to ACT 150.

If the measured heat roller temperature t is lower than the set temperature T in ACT 151, the coil control circuit 76 proceeds to ACT 156. If the set power P of the IH coil 50 is smaller than 400 W in ACT 156, the coil control circuit 76 sets the set power P of the IH coil 50 to 400 W, resets the set power P to a lower limit of the electric power (ACT 157), and returns to ACT 150.

If the set power P of the IH coil 50 is equal to or larger than 400 W in ACT 156, the coil control circuit 76 increases the set power P of the IH coil 50 by, for example, 100 W (ACT 158) and proceeds to ACT 160. If the set power P of the IH coil 50 is equal to or larger than the initial set power Pu of the IH coil 50 in ACT 160, in ACT 161, the coil control circuit 76 sets the electric power of the IH coil 50 to an upper limit of the electric power (the set power P=the initial set power Pu) and returns to ACT 150. If the set power P of the IH coil 50 is smaller than the initial set power Pu of the IH coil 50 in ACT 160, the coil control circuit 76 returns to ACT 150.

The initial set power Pu of the ACT 160 is, for example, Pu=1000 W in the startup mode, Pu=800 W in the standby mode 1 and the printing mode, Pu=0 W in the last paper printing mode, and Pu=800 W in the standby mode 2.

### Control Example 1

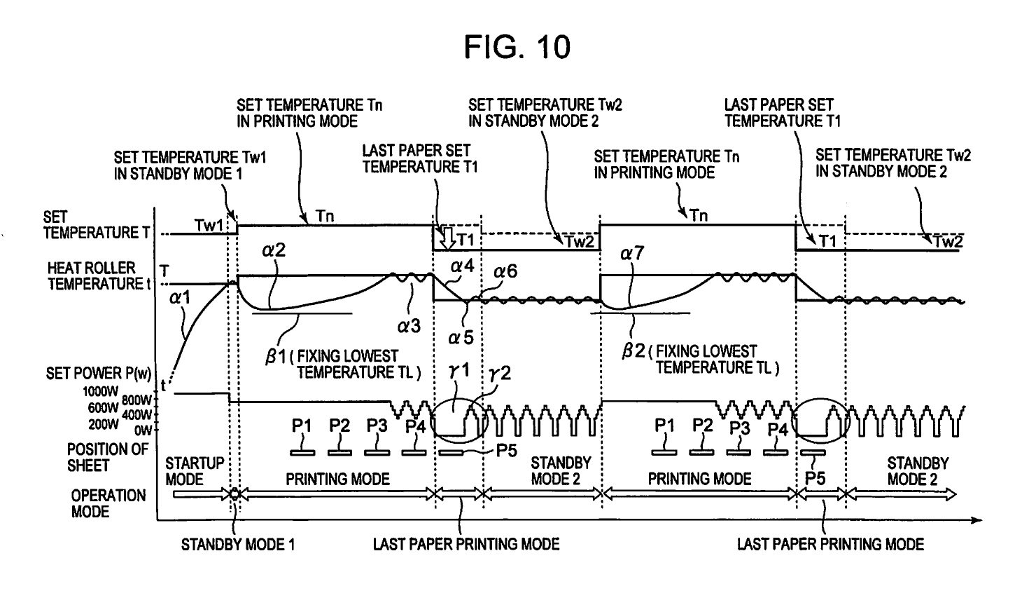

As a control example 1 of the IH coil 50, control for printing five sheets is explained with reference to FIG. 10. The coil control circuit 76 sets the initial set power Pu of the IH coil 50 to 1000 W, sets the set temperature T to Tw1=170° C., and starts the startup mode of the IH coil 50. When the heat roller temperature t input to the CPU 71 from the first or second thermistor 52a or 52b reaches Tw1=170° C. from the cooled state as indicated by α1, the CPU 71 changes the initial set power Pu of the IH coil 50 to 800 W. A control mode of the heat roller 37 shifts from the startup mode to the standby mode 1. Thereafter, while the standby mode 1 is maintained, the coil control circuit 76 controls power setting for the IH coil 50 to be swung between, for example, 0 W to 800 W and keeps the heat roller temperature t at 170° C.

If a print interrupt occurs, the CPU 71 sets the set temperature T of the IH coil 50 to Tn=180° C. and shifts the fixing device 30 from the standby mode 1 to the printing mode. When printing is started immediately after completion of the startup mode, the heat roller temperature t of the heat roller 37 falls, for example, as indicated by α2. In general, until first several sheets P pass the nip 40 of the fixing device 30 after the start of printing, the heat roller temperature t is particularly low. An amount of fall of fixing temperature at the start of printing indicated by α2 changes according to conditions such as environment temperature and the thickness of the sheet P. Therefore, the set temperature Tw1 in the standby mode 1 is set in advance such that the heat roller temperature t (α2) at the start of printing keeps temperature equal to or higher than fixing lowest temperature TL indicated by a solid line β1 even during worst conditions such as allowed lowest environment temperature and allowed maximum sheet thickness. The fixing lowest temperature TL is lowest temperature necessary for the fixing device 30 to obtain satisfactory fixing performance.

The heat roller temperature t fallen at the start of printing rises with time and stabilizes at the set temperature Tn as indicated by α3 while a first sheet P1 to a fourth sheet P4 are printed. Thereafter, before a fifth last sheet P5 enters the nip 40, the CPU 71 shifts the fixing device 30 from the printing mode to the last paper printing mode and sets the set temperature T to T1=160° C. Timing of the shift from the printing mode to the last paper printing mode only has to be timing before the trailing end of the last sheet P5 passes through the nip 40. The timing of the shift from the printing mode to the last paper printing mode may be timing after the last sheet P5 enters the nip 40.

The set temperature T1 in the last paper printing mode is set lower than the set temperature Tn in the printing mode and set higher than the fixing lowest temperature TL (Tn>T1>TL). If the set temperature T of the fixing device 30 is set to lower T1 from Tn during the last paper printing mode, the heat roller temperature t is higher than the set temperature T1=160° C. as indicated by α4. Therefore, the set power P to the IH coil 50 is sequentially reduced in order to lower the heat roller temperature t. The set power P sequentially falls from 800 W to 400 W and eventually falls to 0 W. Setting the set power P to 0 W is substantially the same as a state in which the IH coil 50 is turned off. The IH coil 50 stops as indicated by γ1.

The heat roller temperature t falls according to the fall of the set power P. When the heat roller temperature t is lower than the set temperature T1 in the last paper printing mode as indicated by α5, the set power P is larger than 0 W as indicated by γ2. The set power P is controlled to swing between, for example, 0 W to 800 W according to the change of the heat roller temperature t of the fixing device 30. Since the set power P of the IH coil 50 is controlled to swing, at the finishing of the last paper printing mode, the heat roller temperature t stabilizes at the set temperature T1 as indicated by α6.

After finishing the last paper printing mode, the CPU 71 shifts the IH coil 50 from the last paper printing mode to the standby mode 2. Since the heat roller temperature t stabilizes at T1 lower than the set temperature Tn at the finishing of the last paper printing mode, the heat roller 37 is suppressed from being overshoot during the shift from the last paper printing mode to the standby mode 2.

During the standby mode 2, the coil control circuit 76 controls supply power to the IH coil 50 to swing and keeps the heat roller temperature t at Tw2=T1=160° C. Subsequently, when the IH coil 50 shifts from the standby mode 2 to the printing mode, after the start of printing, the heat roller temperature t of the fixing device 30 is low, for example, as indicated by α7. The set temperature Tw2 in the standby mode 2 is set in advance such that the heat roller temperature t (α17) keeps temperature equal to or higher than the fixing lowest temperature TL indicated by a solid line β2.

However, if the set temperature Tw2 in the standby mode 2 is set higher than the set temperature T1 in the last paper printing mode, when the next printing mode is started immediately after the finishing of the last paper printing mode (before the heat roller temperature t stabilizes at Tw2), it is likely that the heat roller temperature t falls below the fixing lowest temperature TL and causes a fixing failure. Therefore, a relation between the set temperature Tw2 in the standby mode 2 and the set temperature T1 in the last paper printing mode needs to be T1≧Tw2. When the relation between the set temperature Tw2 in the standby mode 2 and the set temperature T1 in the last paper printing mode is T1=Tw2, efficiency is improved in terms of electric power.

### Comparative Example 1

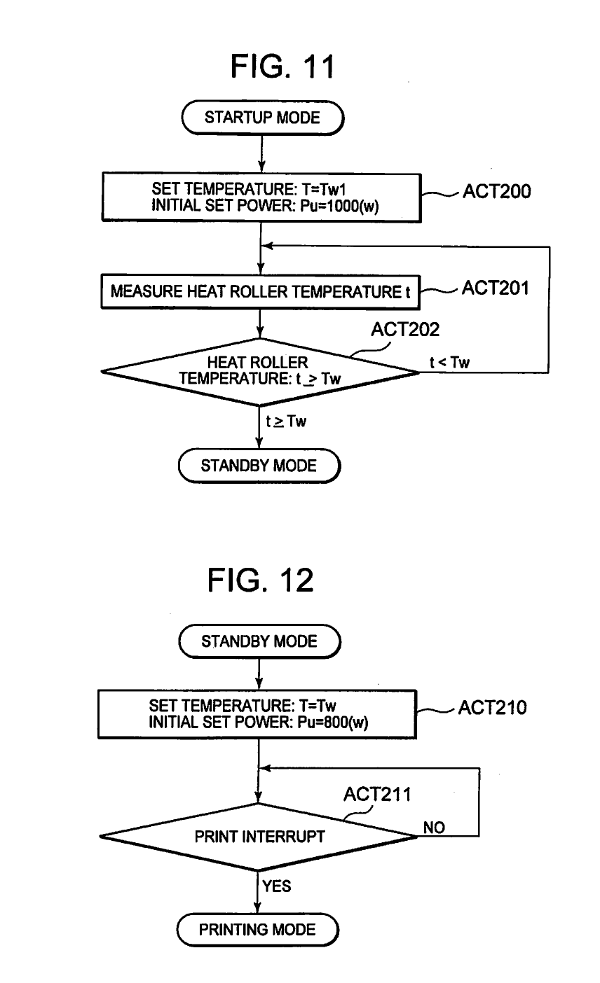

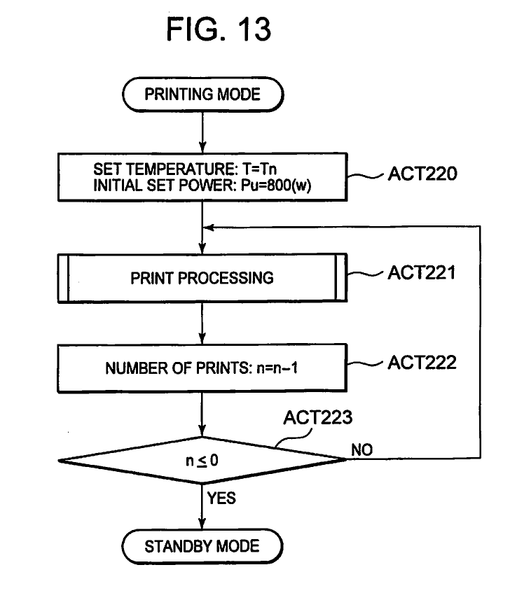

As a comparative example 1 for the control example 1, control performed when the last paper printing mode is not provided in the control mode for the IH coil 50 is explained with reference to FIGS. 11 to 14. In the comparative example 1, at the startup mode, the CPU 71 sets the set temperature T to the startup set temperature Tw (e.g., 170° C.) and sets the initial set power Pu to 1000 W (ACT 200). In ACT 201, the CPU 71 measures the heat roller temperature t. In ACT 202, the CPU 71 waits for the heat roller temperature t to be equal to or higher than the startup set temperature Tw. If the heat roller temperature t is equal to or higher than the startup set temperature Tw in ACT 202, the CPU 71 shifts to the standby mode.

In the comparative example 1, the CPU 71 keeps the set temperature T at the startup set temperature Tw and sets the initial set power Pu to 800 W (ACT 210) and stands by for occurrence of a print interrupt (ACT 211). If a print interrupt occurs (Yes in ACT 211), the CPU 71 shifts to printing mode.

During the printing mode, the CPU 71 sets the set temperature T to the fixing set temperature Tn (e.g., 180° C.) and sets the initial set power Pu to 800 W (ACT 220) and performs print processing (ACT 221). The CPU 71 subtracts 1 from the number of prints n every time the print processing is performed (ACT 222). If the CPU 71 finishes all printings (Yes in ACT 223), the CPU 71 shifts to the standby mode.

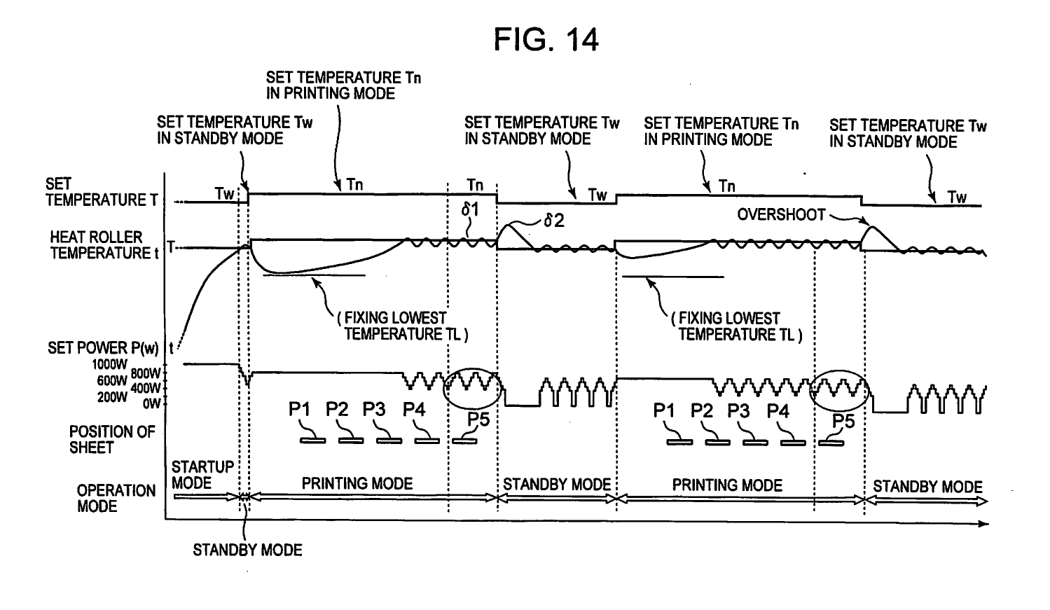

In the comparative example 1, since the set temperature T is Tn at the finishing of the printing mode, the heat roller temperature t in the finishing of printing of the last sheet P5 stabilizes at Tn higher than T1 as indicated by δ1 shown in FIG. 14. In the comparative example 1, the fixing device 30 shifts to the standby mode in a state in which the heat roller temperature t is Tn. Therefore, as indicated by δ2, the heat roller 37 causes overshoot and waste of power consumption occurs. To prevent the influence of the overshoot, cooling operation for the fixing device 30 by, for example, a cooling fan is necessary after the finishing of the printing mode. This prevents power consumption saving.

### Control Example 2

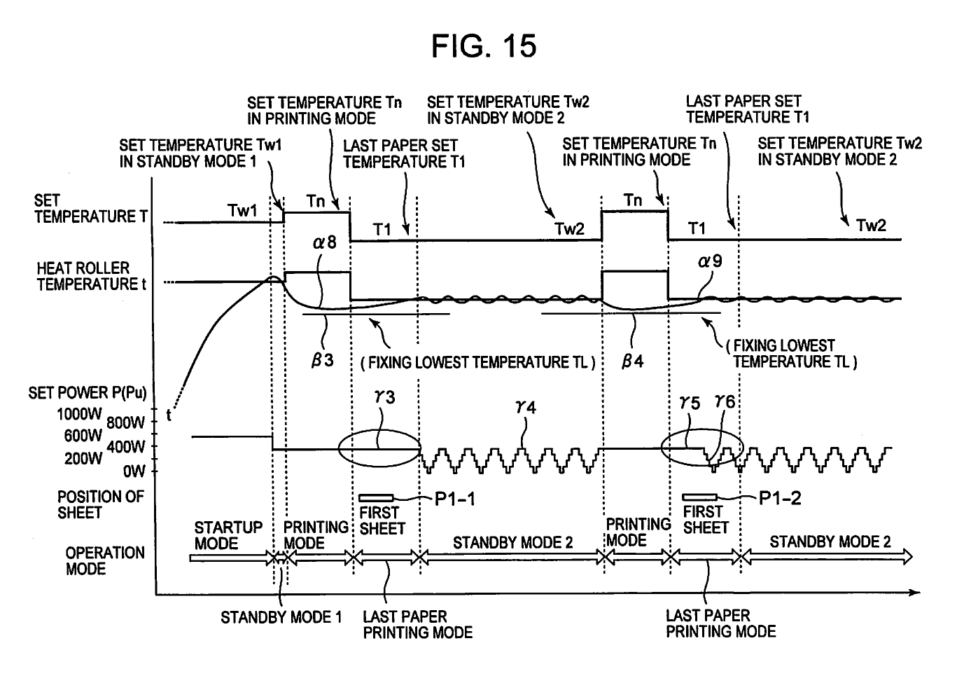

As a control example 2 for the IH coil 50, control performed when the number of prints is one is explained with reference to FIG. 15. While the standby mode 1 at Tw1=170° C. is maintained after the startup mode, if a print interrupt for one sheet occurs, the CPU 71 shifts to the printing mode and sets the set temperature T of the fixing heater 37 to Tn=180° C. The heat roller temperature t falls as indicated by α8 according to the start of printing immediately after the startup mode but keeps temperature equal to or higher than the fixing lowest temperature T1 indicated by a solid line β3.

Since the number of prints is one and the last paper is printed, after the start of the printing mode, before a first sheet P1-1 (last paper) enters the nip 40 of the fixing device 30, the fixing device 30 shifts from the printing mode to the last paper printing mode. The CPU 71 sets the set temperature T to T1=160° C. lower than Tn. However, during the shift to the last paper printing mode, the heat roller temperature t does not reach T1=160° C. Therefore, during the shift to the last paper printing mode, although the set temperature T is lowered to T1=160° C., the coil control circuit 76 keeps set power 800 W supplied to the IH coil 50 as indicated by γ3.

After finishing the last paper printing mode, the fixing device 30 shifts from the last paper printing mode to the standby mode 2. However, at the end of the last paper printing mode, the heat roller temperature t falls to T1=160° C. lower than the set temperature T. Therefore, the heat roller 37 is suppressed from being overshoot during the shift from the last paper printing mode to the standby mode 2.

Thereafter, during the standby mode 2, the coil control circuit 76 controls set power of the IH coil 50 to swing between, for example, 0 W to 800 W as indicated by γ4 and keeps the heat roller temperature t at Tw2=160° C. If a print interrupt for one sheet occurs during the standby mode 2, the CPU 71 shifts the fixing device 30 to the printing mode. The CPU 71 sets the set temperature T of the fixing heater 37 to Tn=180° C. The coil control circuit 76 changes the initial set power of the IH coil 50 to 800 W.

After the start of the printing mode, before a first sheet P1-2 (last paper) enters the nip 40 of the fixing device 30, the fixing device 30 shifts from the printing mode to the last paper printing mode. However, during the shift to the last paper printing mode, the heat roller temperature t does not reach T1=160° C. Therefore, during the shift to the last paper printing mode, although the set temperature T is lowered to T1=160° C., the coil control circuit 76 keeps the set power P to the IH coil 50 at 800 W as indicated by γ5.

When the heat roller temperature t reaches T1 as indicated by α9 while the sheet P2-2 is passing through the nip 40, the coil control circuit 76 controls set power of the IH coil 50 to swing as indicated by γ6 and keeps the heat roller temperature t at T1.

After finishing the last paper printing mode, the fixing device 30 shifts from the last paper printing mode to the standby mode 2. However, at the finishing of the last paper printing mode, the heat roller temperature t keeps T1=160° C. lower than the set temperature Tn. Therefore, at the finishing of the last paper printing mode, the fixing device 30 is suppressed from being overshoot.

### Comparative Example 2

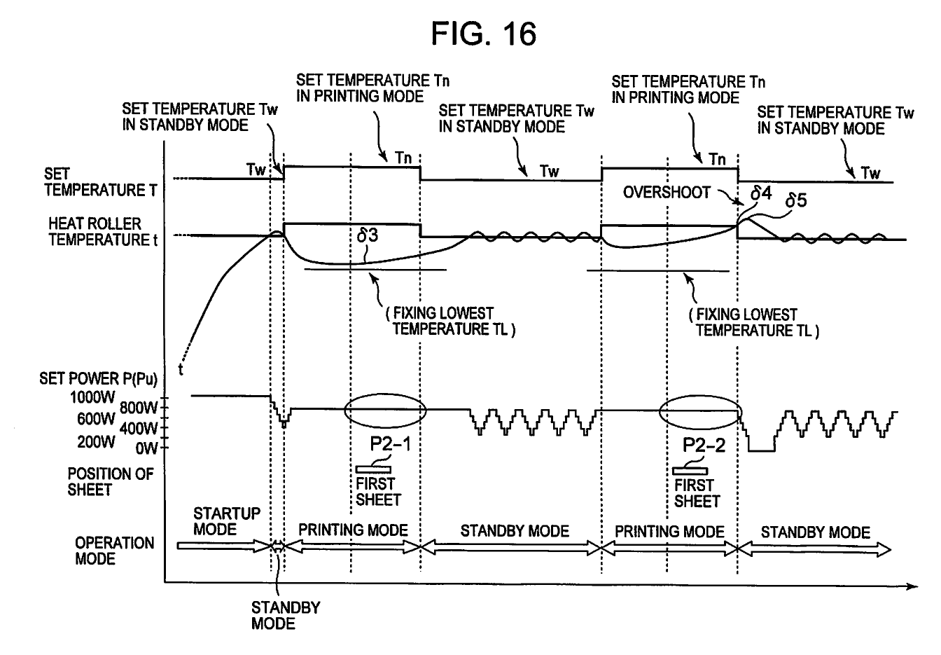

As a comparative example 2 for the control example 2, control for keeping the set temperature T of the fixing heater 37 at Tn=180° C. and printing one sheet without providing the last paper printing mode is explained with reference to FIG. 16. In the comparative example 2, if a print interrupt for one sheet occurs while the standby mode at Tw is maintained after the startup mode, the fixing heater 37 shifts to the printing mode. During the passage of a first sheet P2-1 (last paper), the heat roller temperature t does not reach T1 as indicated by δ3. Therefore, the heat roller 37 does not cause overshoot during the shift from the printing mode to the standby mode.

If a print interrupt for a first sheet P2-2 occurs during the standby mode, the fixing heater 37 shifts to the printing mode. At the finishing of the printing mode for the first sheet P2-2 (last paper), the heat roller temperature t reaches the set temperature Tn as indicated by δ4. Therefore, when the fixing heater 37 finishes the printing mode and shifts to the standby mode, the heat roller 37 causes overshoot as indicated by δ5 and waste of power consumption occurs. To prevent excessively high fixing temperature after the finishing of printing due to the overshoot, cooling operation for the fixing device 30 by, for example, a cooling fan is necessary after the finishing of printing. This prevents power consumption saving.

According to the first embodiment, during the last paper printing mode, the set temperature T is set from Tn in the printing mode to lower T1. The set temperature T1 is lowered to T1, whereby set power supplied to the IH coil 50 during the last paper printing mode is reduced and power consumption is reduced. Since the set temperature is set to T1 during the last paper printing mode, the fixing device 30 is suppressed from being overshoot during the shift from the last paper printing mode to the standby mode 2 and waste of power consumption is eliminated. Power consumption for cooling the fixing device 30 is reduced. A reduction in power consumption in the standby mode 2 is realized by setting the set temperature T1 in the last paper printing mode and the set temperature Tw2 in the standby mode 2 to be the same.

### Second Embodiment

A second embodiment is explained below. The second embodiment is different from the first embodiment in a heating member. In the second embodiment, the same components as the components explained in the first embodiment are denoted by the same reference numerals and signs and detailed explanation of the components is omitted.

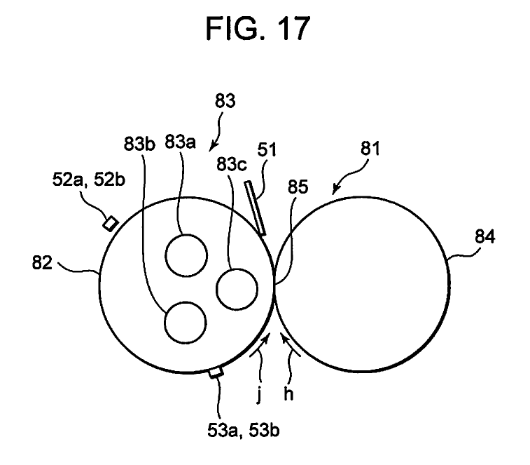

In the second embodiment, as shown in FIG. 17, a fixing device 81 includes a fixing heater 83 that is a lamp heater configured to heat a heat roller 82 of the fixing device 81 with radiation heat. The heat roller 82 has, for example, a surface layer of fluorine resin or the like around a roller of aluminum having thickness of 0.8 mm. A press roller 84 has, for example, an elastic surface layer of silicon rubber or the like on a cored bar of iron. The heat roller 82 and the press roller 84 come into press-contact with each other to form a nip 85. The press roller 84 drivingly rotates in an arrow h direction. The heat roller 82 is driven to rotate in an arrow j direction following the press roller 84.

The heat roller 82 includes the fixing heater 83 on the inside of a hollow. The fixing heater 83 includes, for example, a center lamp 83a having power consumption of 600 W configured to heat a center area of the heat roller 82, side lamps 83b having power consumption of 600 W configured to heat areas on both sides of the heat roller 82, an auxiliary lamp 83c having power consumption of 280 W configured to cover the center area and the areas on both the sides of the heat roller 82. For example, when an image is fixed on the sheet P having width of the “A4” landscape size (210 mm) of the JIS standard, the center lamp 83a is turned on to heat the center area of the heat roller 82. When the entire length of the heat roller 82 is heated, the center lamp 83a and the side lamps 83b are turned on. When a larger heat quantity is necessary, for example, at the startup mode or during fixing on thick paper, the auxiliary lamp 83c is turned on.

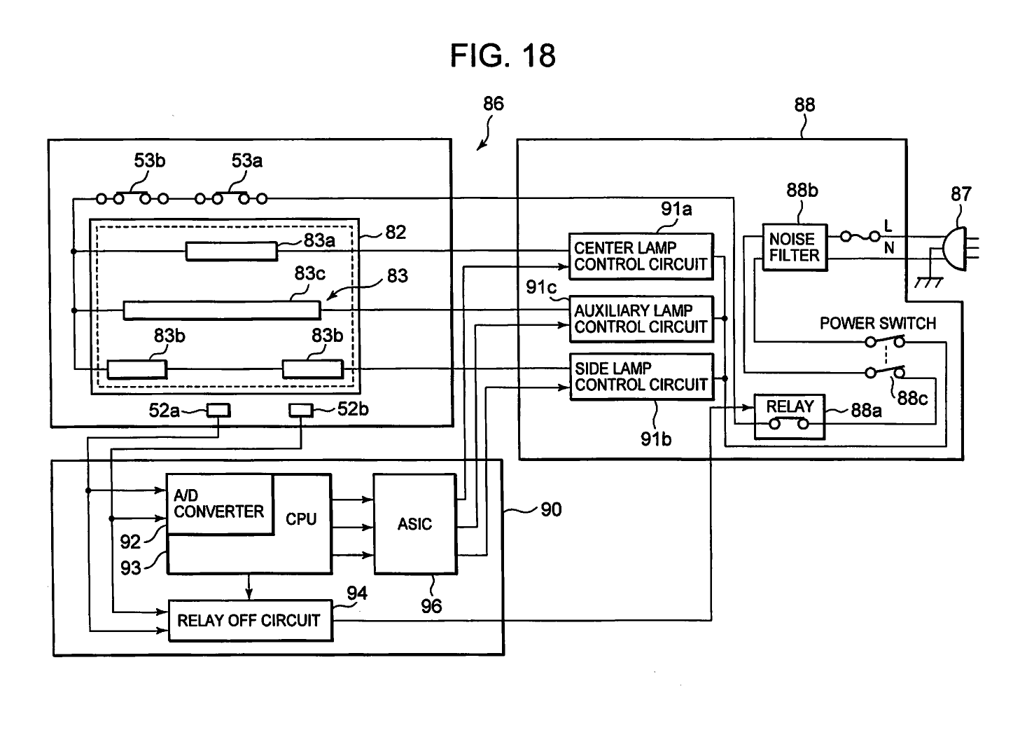

A control system 86 for the fixing heater 83 shown in FIG. 18 includes a switching circuit 88 configured to on-off control power supply from a power supply 87 to the center lamp 83a, the side lamps 83b, and the auxiliary lamp 83c. The control system 86 includes a heater control board 90 configured to feed back control based on temperature detection results by the first and second thermistors 52a and 52b to the switching circuit 88.

The switching circuit 88 includes a center lamp control circuit 91a, a side lamp control circuit 91b, and an auxiliary lamp control circuit 91c configured to respectively on-off control the center lamp 83a, the side lamps 83b, and the auxiliary lamp 83c. The switching circuit 88 connects the center lamp control circuit 91a, the side lamp control circuit 91b, and the auxiliary lamp control circuit 91c to the power supply 87 via a relay 88a, a noise filter 88b, and a power switch 88c.

The heater control board 90 includes an A/D converter 92, a CPU 93, a relay off circuit 94, and an ASIC 96 for the center lamp control circuit 91a, the side lamp control circuit 91b, and the auxiliary lamp control circuit 91c. The CPU 93 controls the entire color copying machine 1.

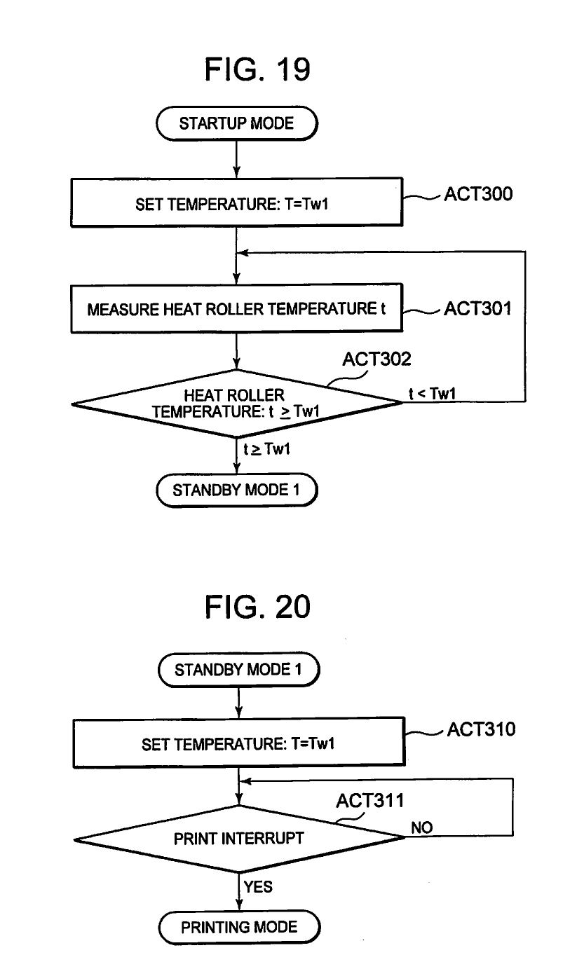

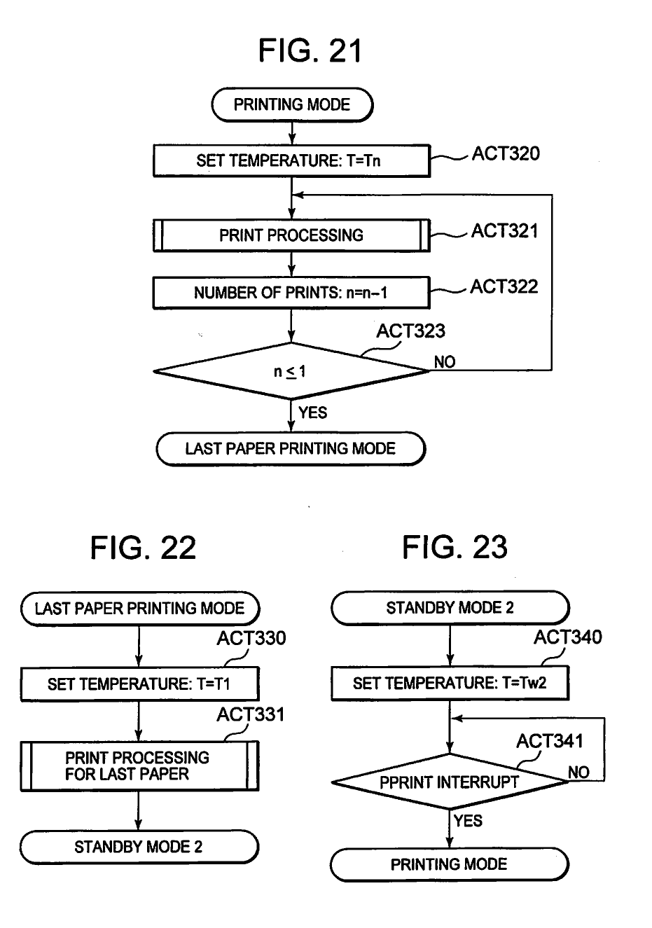

Setting of control for the fixing heater 83 is explained below with reference to FIGS. 19 to 24. At the start of the startup mode, the ASIC 96 sets the set temperature T of the fixing heater 83 to the set temperature Tw1 (e.g., 170° C.) (ACT 300).

In ACT 301, the first and second thermistors 52a and 52b measure the heat roller temperature t. The CPU 93 waits for the heat roller temperature t to be equal to or higher than the set temperature Tw1. If the heat roller temperature t is equal to or higher than the set temperature Tw1 in ACT 302, the CPU 93 shifts to the standby mode 1.

In the standby mode 1, the ASIC 96 keeps the set temperature T of the standby mode 1 of the fixing heater 83 at the same set temperature Tw1 as set temperature for start up (ACT 310). The CPU 93 stands by for occurrence of a print interrupt (ACT 311). If a print interrupt occurs (Yes in ACT 311), the CPU 93 shifts to the printing mode.

At the start of the printing mode, the CPU 93 sets the set temperature T of the fixing heater 83 to the set temperature Tn (e.g., 180° C.), which is first fixing set temperature (ACT 320). The color copying machine 1 performs print processing (ACT 321). The CPU 93 subtracts from the number of prints n every time the print processing is performed (ACT 322) and, if the number of prints n is equal to or smaller than 1 (Yes in ACT 323), shifts to the last paper printing mode.

During the last paper printing mode, the CPU 93 sets the set temperature T of the fixing heater 83 to set temperature T1 (e.g., 160° C.), which is second fixing set temperature (ACT 330). The color copying machine 1 performs print processing for last paper (ACT 331). The CPU 93 shifts to the standby mode 2.

In the standby mode 2, the CPU 93 sets the set temperature T of the fixing heater 83 to the set temperature Tw2 (e.g., 170° C.) in the standby mode 2 (ACT 340). The CPU 93 stands by for occurrence of a print interrupt (ACT 341). If a print interrupt occurs (Yes in ACT 341), the CPU 93 shifts to the printing mode.

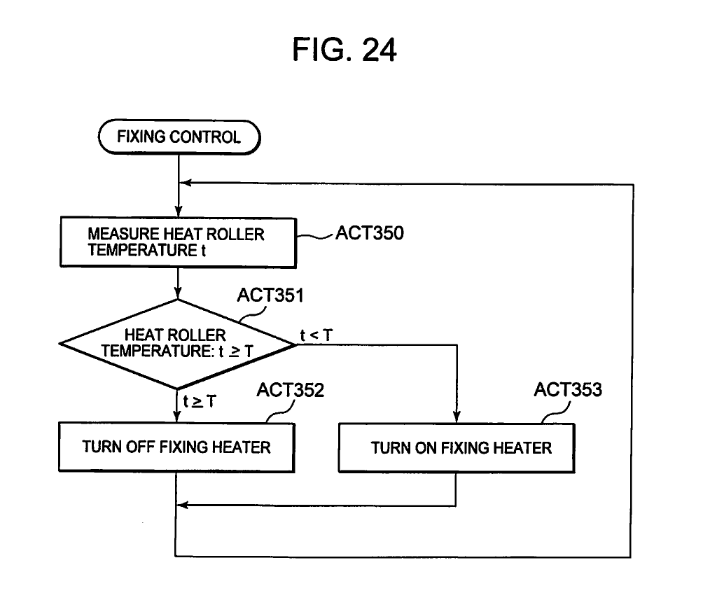

While the setting for control of the fixing heater 83 shown in FIGS. 19 to 23 is carried out, the fixing device 81 performs fixing control according to a flowchart shown in FIG. 24. In the fixing device 81, the first and second thermistors 52a and 52b measure the heat roller temperature t of the heat roller 82 (ACT 350). If the measured heat roller temperature t is equal to or higher than the set temperature T in ACT 351, the ASIC 96 turns off the fixing heater 83 (ACT 352) and returns to ACT 350.

If the measured heat roller temperature t is lower than the set temperature T in ACT 351, the ASIC 96 proceeds to ACT 353. In ACT 353, the ASIC 96 turns on the fixing heater 83 and returns to ACT 350.

### Control Example 3

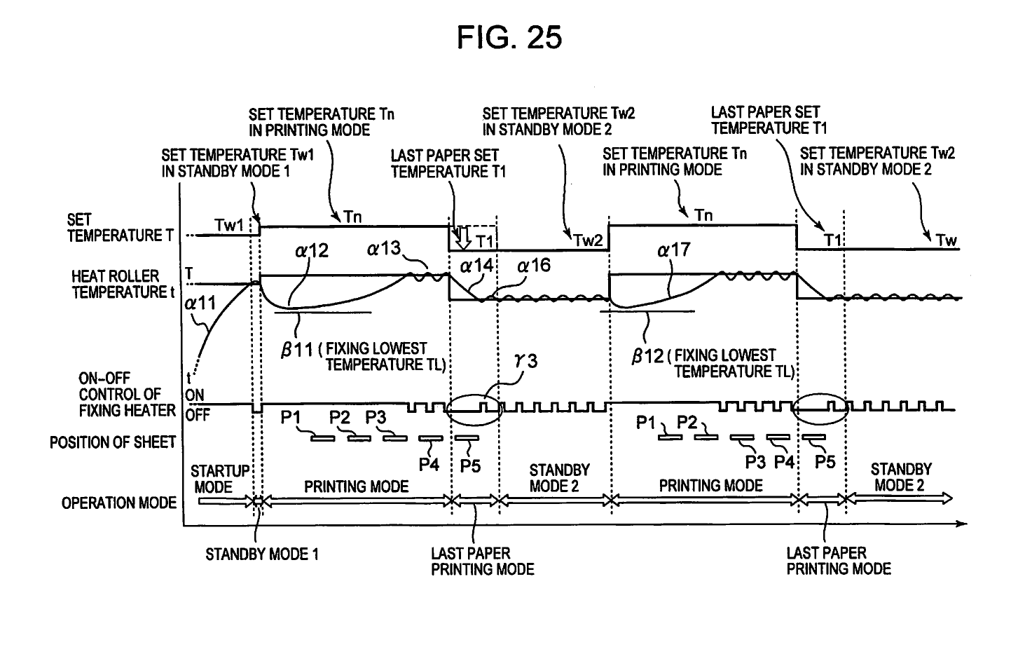

As a control example 3 of the fixing heater 83, control for printing five sheets is explained with reference to FIG. 25. The ASIC 96 turns on the fixing heater 83 and starts the startup mode of the fixing heater 83. The heat roller temperature t rises as indicated by all. When the heat roller temperature t reaches Tw1=170° C., the fixing heater 83 shifts from the startup mode to the standby mode 1 and the ASIC 96 turns off the fixing heater 83. Thereafter, while the standby mode 1 is maintained, the ASIC 96 on-off controls the fixing heater 83 such that the heat roller temperature t keeps Tw1=170° C.

If a print interrupt occurs, the CPU 93 sets the set temperature T to Tn=180° C. and turns on and off the fixing heater 83 in the printing mode. When the fixing device 81 starts printing immediately after the startup mode, the heat roller temperature t falls, for example, as indicated by α12. However, the set temperature Tw1 of the standby mode 1 is set in advance such that the heat roller temperature t (α12) keeps temperature equal to or higher than the fixing lowest temperature TL indicated by a solid line β11 even during worst conditions.

The heat roller temperature t fallen at the start of printing rises with time and stabilizes at the set temperature Tn as indicated by α13. Thereafter, before the fifth last sheet P5 enters the nip 85, the CPU 93 shifts the fixing device 81 from the printing mode to the last paper printing mode. The CPU 93 sets the set temperature T of the fixing motor 83 to T1=160° C. lower than Tn.

Since the heat roller temperature t is higher than the set temperature T1, the ASIC 96 turns off the fixing heater 83 as indicated by γ3. The heat roller temperature t falls as indicated by α14. At the finishing of the last paper printing mode, the heat roller temperature t stabilizes at the set temperature T1 in the last paper printing mode as indicated by α16. The heat roller 82 is suppressed from being overshoot during shift from the last paper printing mode to the standby mode 2.

After finishing the last paper printing mode, the CPU 93 shifts the control of the fixing heater 83 from the last paper printing mode to the standby mode 2. During the standby mode 2, the ASIC 96 on-off controls the fixing heater 83 and keeps the heat roller temperature t at Tw2=T1=160° C. Further, when the CPU 93 shifts the control of the fixing heater 83 from the standby mode 2 to the printing mode, after the start of printing, the heat roller temperature t of the fixing device 81 falls, for example, as indicated by α17. The set temperature Tw2 in the standby mode 2 is set in advance such that the heat roller temperature t (α17) keeps temperature equal to or higher than the fixing lowest temperature TL indicated by a solid line β12 under any fixing condition.

However, a relation between the set temperature Tw2 in the standby mode 2 and the set temperature T1 in the last paper printing mode needs to be T1≧Tw2. When the relation between the set temperature Tw2 in the standby mode 2 and the set temperature T1 in the last paper printing mode is T1=Tw2, efficiency is improved in terms of electric power.

### Comparative Example 3

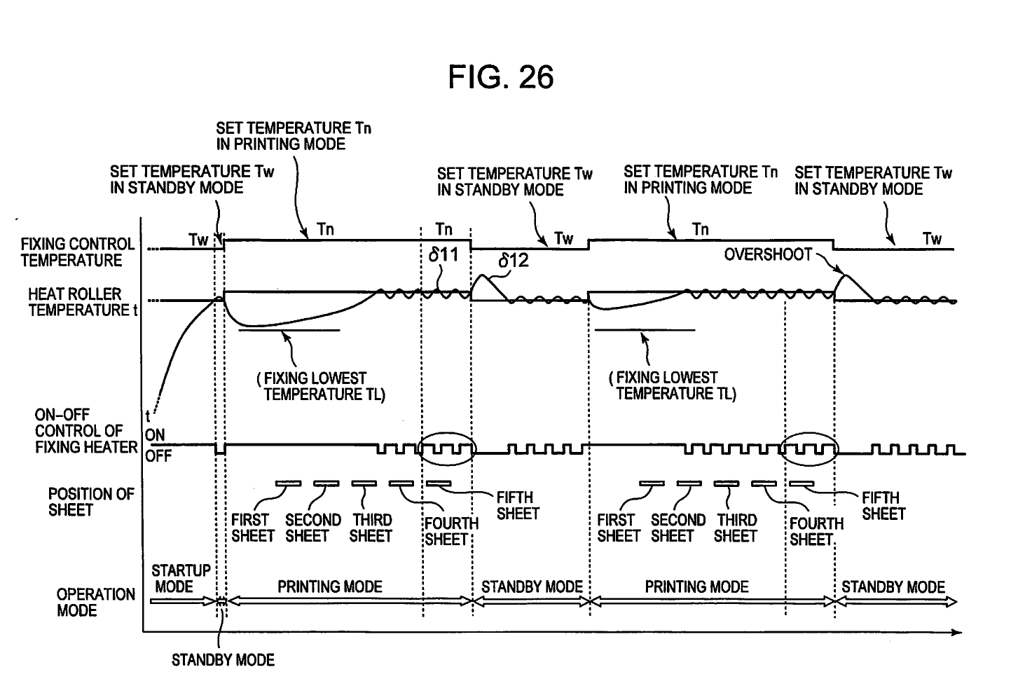

As a comparative example 3 for the control example 3, control performed when the last paper printing mode is not provided in the control mode for the fixing heater 83 is explained with reference to FIG. 26. In the comparative example 3, at the finishing of the last paper printing mode, the heat roller temperature t stabilizes at Tn (e.g., 180° C.) higher than T1 as indicated by δ11. In the comparative example 3, the fixing device 81 shifts to the standby mode in a state in which the heat roller temperature t is Tn. Therefore, as indicated by δ12, the heat roller 82 causes overshoot and waste of power consumption occurs. To prevent the influence of the overshoot, cooling operation for the fixing device 81 by, for example, a cooling fan is necessary after the finishing of the printing. This prevents power consumption saving.

### Control Example 4

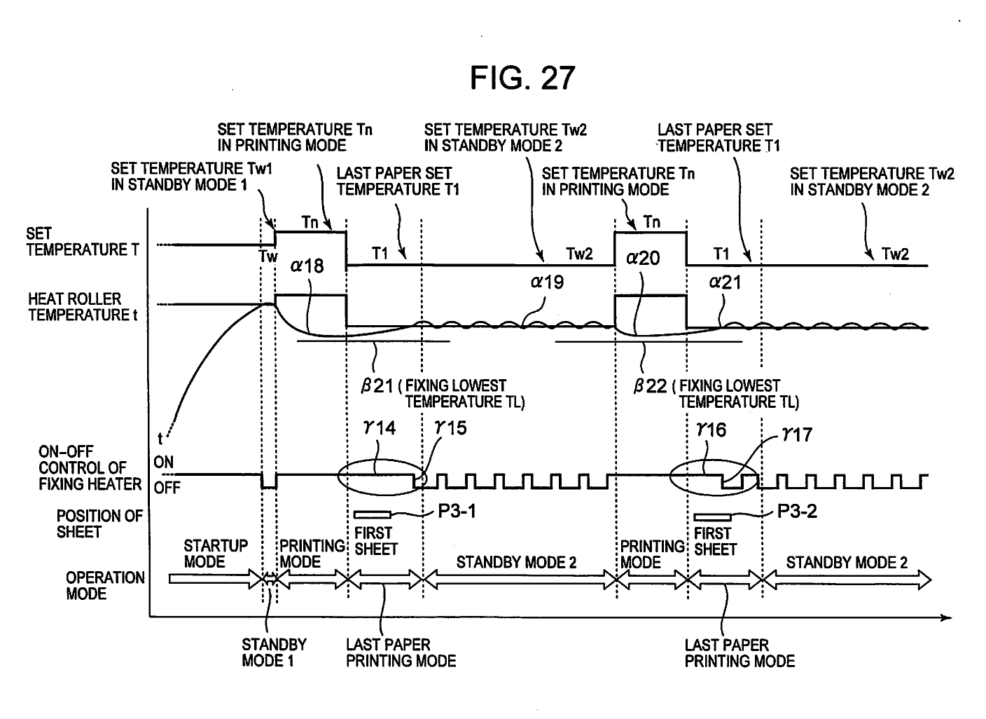

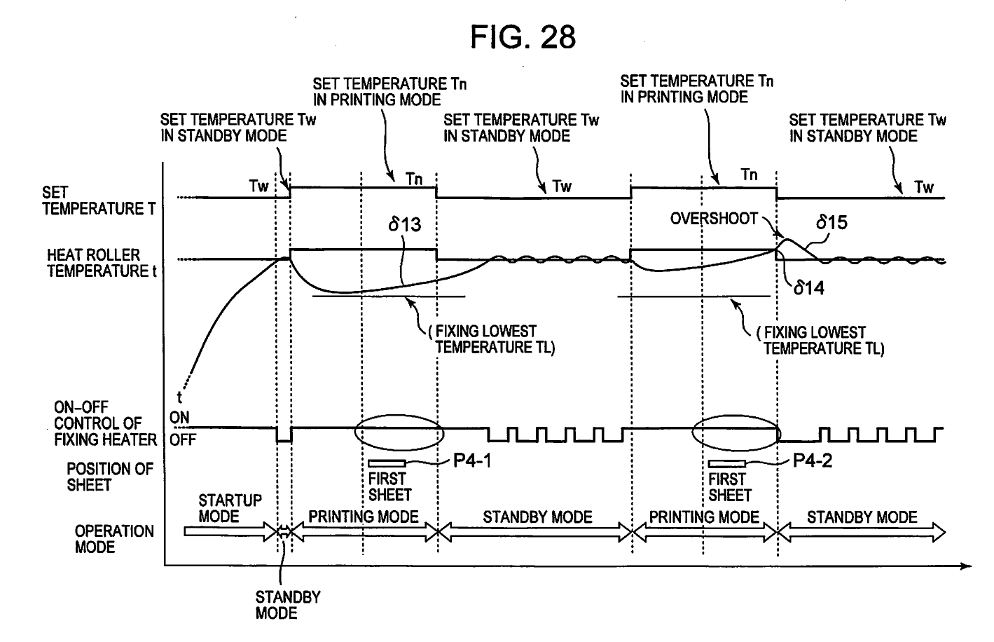

As a control example 4 for the fixing heater 83, control performed when the number of prints is one is explained with reference to FIG. 27. While the standby mode 1 at Tw1=170° C. is maintained after the startup mode, if a print interrupt for one sheet occurs, the CPU 93 shifts to the printing mode and sets the set temperature T of the fixing heater 83 to Tn=180° C. When the fixing device 81 starts printing immediately after completion of the startup mode, the heat roller temperature t falls, for example, as indicated by α18. Therefore, the ASIC 96 turns on the fixing heater 83 such that the heat roller 82 keeps Tn=180° C. Although the heat roller temperature t falls according to the start of printing immediately after the startup mode, the ASIC 96 keeps temperature equal to or higher than the fixing lowest temperature TL indicated by a solid line β21.

Since the number of prints is one and the last paper is printed, after the start of the printing mode, before a first sheet P3-1 (last paper) enters the nip 85 of the fixing device 81, the fixing device 81 shifts from the printing mode to the last paper printing mode. The CPU 93 sets the set temperature T of the fixing heater 83 to T1=160° C. lower than Tn. However, during the shift to the last paper printing mode, the heat roller temperature t does not reach T1=160° C. Therefore, during the shift to the last paper printing mode, although the set temperature T of the fixing heater 83 is lowered to T1=160° C., the ASIC 96 keeps the fixing heater 83 on as indicated by γ14.

Thereafter, when the heat roller temperature t reaches T1=160° C. during execution of the last paper printing mode, as indicated by γ15, the ASIC 96 turns off the fixing heater 83. When the fixing device 81 finishes the last paper printing mode, the control of the fixing heater 83 of the fixing device 81 shifts from the last paper printing mode to the standby mode 2. However, when the sheet P3-1 passes through the nip 85 of the fixing device 81, the heat roller temperature t does not reach T1=160° C. lower than the set temperature Tn. Therefore, the fixing device 81 is suppressed from being overshoot during the shift from the last paper printing mode to the standby mode 2.

Thereafter, as indicated by α19, while the heat roller temperature t keeps Tw2=160° C. in the standby mode 2, if a print interrupt for one sheet occurs, the CPU 93 shifts the fixing device 81 to the printing mode. The CPU 93 sets the set temperature T of the fixing heater 83 to Tn=180° C. The ASIC 96 turns on the fixing heater 83.

For example, as indicated by α20, the heat roller temperature t falls according to the start of the printing mode. The ASIC 96 on-off controls the fixing heater 83 such that the heat roller 82 keeps Tn=180° C. After the start of the printing mode, before a first sheet P3-2 (last paper) enters the nip 85 of the fixing device 81, the CPU 93 shifts the fixing device 81 from the printing mode to the last paper printing mode. The CPU 93 sets the set temperature T of the fixing heater 83 to T1=160° C. lower than Tn. However, during the shift to the last paper printing mode, the heat roller temperature t does not reach T1=160° C. Therefore, during the shift to the last paper printing mode, although the set temperature T of the fixing heater 83 is lowered to T1=160° C., the ASIC 96 keeps the fixing heater 83 on as indicated by γ16.

While the sheet P3-2 is passing through the nip 85, when the heat roller temperature t reaches T1=160° C. as indicated by α21, the ASIC 96 turns off the fixing heater 83 as indicated by γ17. Thereafter, the ASIC 96 on-off controls the fixing heater 83 such that the heat roller temperature t keeps T1. After finishing the last paper printing mode, the fixing device 81 shifts from the last paper printing mode to the standby mode 2. When the sheet P3-2 passes through the nip 85 of the fixing device 81, the heat roller temperature t is T1=160° C. lower than Tn. During the shift from the last paper printing mode to the standby mode 2, the heat roller 82 is suppressed from being overshoot.

### Comparative Example 4

As a comparative example 4 for the control example 4, control for keeping the set temperature T of the fixing heater 83 at Tn and printing one sheet without providing the last paper printing mode is explained. In the comparative example 4, if a print interrupt for one sheet occurs while the standby mode 1 at Tw1 is maintained after the startup mode, the fixing heater 83 shifts to the printing mode. During the passage of a first sheet P4-1 (last paper), the heat roller temperature t does not reach T1 as indicated by δ13. Therefore, the heat roller 82 does not cause overshoot during the shift from the printing mode to the standby mode.

When the printing of one sheet is finished, the fixing heater 83 shifts to the standby mode. The fixing heater 83 is on-off controlled and keeps the heat roller temperature t at the set temperature Tw. If a print interrupt for the first sheet P4-2 occurs during the standby mode, the fixing heater 83 shifts to the printing mode. When the printing mode of the first sheet P4-2 (last paper) finishes, as indicated by δ14, the heat roller temperature t reaches the set temperature Tn. Therefore, when the fixing heater 83 finishes the printing mode and shifts to the standby mode, as indicated by δ15, the heat roller 82 causes overshoot and waste of power consumption occurs. To prevent excessively high fixing temperature after the finishing of printing due to the overshoot, cooling operation by, for example, a cooling fan is necessary after the finishing of printing. This prevents power consumption saving.

According to the second embodiment, during the last paper printing mode, the set temperature T of the fixing heater 83 is set from Tn in the printing mode to lower T1, whereby on-time of the fixing heater 83 during the last paper printing mode can be reduced and power consumption can be reduced. Since the set temperature T is lowered to T1 during the last paper printing mode, the fixing device 81 is suppressed from being overshoot during the shift from the last paper printing mode to the standby mode 2 and waste of power consumption is eliminated. Power consumption for cooling the fixing device 81 is reduced. Power consumption in the standby mode 2 is reduced by setting the set temperature T1 in the last paper printing mode and the set temperature Tw2 in the standby mode 2 to be the same.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. A fixing device comprising:
a fixing member configured to cause a recording medium to pass therethrough and subject the recording medium to fixing processing;
a heating member configured to heat the fixing member; and
a control member configured to control the heating member at two fixing set temperatures during a printing mode for the recording medium fed last.

2. The device of claim 1, wherein the control member controls the heating member at first fixing set temperature at start of the printing mode and controls the heating member at second fixing set temperature before the fixing member finishes passage of the recording medium fed last.

3. The device of claim 2, wherein the control member changes, when the recording medium fed last enters the fixing member, the control of the heating member from the control at the first fixing set temperature to the control at the second fixing set temperature.

4. The device of claim 2, wherein the second fixing set temperature is lower than the first fixing set temperature.

5. The device of claim 2, wherein the second fixing set temperature is the same as standby control temperature of the heating member in a standby mode.

6. The device of claim 1, wherein
the heating member is a lamp heater configured to heat the fixing member with radiation heat, and
the control member on-off controls the lamp heater according to a detection result of a fixing temperature sensor.

7. The device of claim 1, wherein
the heating member is an induction heater configured to heat the fixing member with induction current, and
the control member controls supply power to the induction heater to swing according to a detection result of a fixing temperature sensor.

8. An image forming apparatus comprising:
an image forming section configured to form a toner image on a recording medium;
a fixing member configured to cause the recording medium having the toner image to pass there through and fix the toner image on the recording medium;
a heating member configured to heat the fixing member; and
a control member configured to control the heating member at two fixing set temperatures during a printing mode for the recording medium fed last.

9. The apparatus of claim 8, wherein the control member controls the heating member at first fixing set temperature at start of the printing mode and controls the heating member at second fixing set temperature before the fixing member finishes passage of the recording medium fed last.

10. The apparatus of claim 9, wherein the control member changes, when the recording medium fed last enters the fixing member, the control of the heating member from the control at the first fixing set temperature to the control at the second fixing set temperature.

11. The apparatus of claim 9, wherein the second fixing set temperature is lower than the first fixing set temperature.

12. The apparatus of claim 9, wherein the second fixing set temperature is the same as standby control temperature of the heating member in a standby mode.

13. The apparatus of claim 8, wherein
the heating member is a lamp heater configured to heat the fixing member with radiation heat, and
the control member on-off controls the lamp heater according to a detection result of a fixing temperature sensor.

14. The apparatus of claim 8, wherein
the heating member is an induction heater configured to heat the fixing member with induction current, and
the control member controls supply power to the induction heater to swing according to a detection result of a fixing temperature sensor.

15. An image forming method comprising:
forming a toner image on a recording medium; and
controlling a fixing member at two set control temperatures while forming the toner image on the recording medium fed last.

16. The method of claim 15, wherein the fixing member is controlled at first fixing set temperature at start of formation of the toner image on the recording medium fed last and is controlled at second fixing set temperature before the fixing member ends fixing of the toner image on the recording medium fed last.

17. The method of claim 16, wherein the fixing member is controlled, before the recording medium fed last enters the fixing member, the first fixing set temperature to the second fixing set temperature.

18. The method of claim 16, wherein the second fixing set temperature is lower than the first fixing set temperature.

19. The method of claim 16, wherein the second fixing set temperature is the same as standby control temperature for controlling the fixing member while the formation of the toner image is put on standby.
